(19) United States
(12) Patent Application Publication
(10) Pub. No.: US 2026/0251292 A1
(43) Pub. Date: Aug. 27, 2026

(54) A KITCHEN APPLIANCE

(71) Applicant: Breville Pty Limited, Alexandria, New South Wales (AU)

(72) Inventors: Eddie SIU, Alexandria, New South Wales (AU); Richard Lehonde HOARE, Alexandria, New South Wales (AU); Joshua Matthew MORABITO, Alexandria, New South Wales (AU); Scott Barrington FRYER, Alexandria, New South Wales (AU)

(73) Assignee: Breville Pty Limited, Alexandria, New South Wales (AU)

(21) Appl. No.: 18/877,349

(22) PCT Filed: Jun. 30, 2023
(86) PCT No.: PCT/AU2023/050608

§ 371 Date: Dec. 20, 2024

(30) Foreign Application Priority Data
Jun. 30, 2022 (AU) 2022901845

(51) Int. Cl. F21V 33/00; A47J 31/44; F21Y 103/33; F21Y 115/10

(52) U.S. Cl. CPC F21V 33/0044; A47J 31/4457; A47J 2203/00; F21Y 2103/33; F21Y 2115/10

(57) ABSTRACT

There is disclosed herein a kitchen appliance including: a lighting arrangement including: a light pipe (50) having a start portion (60), an end portion (62), and an upper surface (54) and an opposing lower surface (56), wherein the upper surface (54) includes a plurality of facets (68) that extend along a length of the light pipe (50) between the start and end portions (60, 62); and a light source (75) associated with the light pipe (50) and configured to emit light along the length of the light pipe (50).

### FIELD

The present invention relates to kitchen appliances such as coffee machines. In particular, the present invention relates to lighting systems for coffee machines.

The invention has been developed primarily for use with coffee machines, and will be described hereinafter with reference to this application. However, it will be appreciated that the invention is not limited to this particular field of use, and may also be employed in other applications involving lighting systems in a kitchen appliance.

### BACKGROUND

Kitchen appliances typically include one or more visual elements to communicate information regarding the state of the kitchen appliance and/or the components thereof. For example, coffee machines may include a water level window located at the front of the device which provides an indication regarding the level of water in the water container of the coffee machine, and the water container is typically located at the rear of the machine. In coffee machines without such water level windows, the user would inspect the water container itself to determine the level of water available. It is understood that the level of water in coffee machines and other kitchen appliances is critical to their function.

A disadvantage of such known visual elements in a kitchen appliance is that the visibility of such elements may be poor, or such visual elements may otherwise be difficult for the user to readily inspect. For example, water level windows of coffee machines may be located around a poorly illuminated area of the coffee machine underneath the head of the coffee machine. This area may also be susceptible to coffee splatter during the coffee extraction process, which may cause the water level window to be obscured over time. In coffee machines without water level windows, the user needs to remember to look at the water container located at the rear of the device, which is a step that is commonly missed, leading to the coffee extraction process being initiated without sufficient water. The lack of a readily apparent display element may also detract from the user experience of the kitchen appliance. Further, sensing the water level and prompting the user to fill the water container may not always be possible. In addition to water level windows of an appliance in the example provided above, other user interaction zones (such as the coffee preparation area of a coffee machine) of an appliance may also be located in a poorly illuminated area.

### SUMMARY

It is an object of the present invention to substantially overcome, or at least ameliorate, one or more of the disadvantages of existing arrangements, or at least provide a useful alternative to existing arrangements.

There is disclosed herein a kitchen appliance including:
a lighting arrangement including:
a light pipe having a start portion, an end portion, and an upper surface and an opposing lower surface, wherein the upper surface includes a plurality of facets that extend along a length of the light pipe between the start and end portions; and
a light source associated with the light pipe and configured to emit light along the length of the light pipe.

The light pipe may be a generally circular or ring-shaped body.

The light source is a single LED.

The facets may be arranged along as a spiral path that progresses along the upper surface of the light pipe.

The facets may have varying sizes or heights.

The facets that are located towards the end portion may be larger than the facets that are located towards the start portion.

The size of the facets may gradually increase between the start and end portions.

The facets have varying angles relative to a horizontal axis of the light pipe.

Each facet may be disposed at an angle of between 0 to 90 degrees relative to the horizontal axis.

The start portion and the end portion may be separated by a height.

The height of the end portion may be larger than the height of the start portion.

The facets that are located towards the end portion may have a light reflection efficiency of approximately 100% and the facets that are located towards the start portion may have a light reflection efficiency of between approximately 50 to 60%.

The light pipe may be formed from an acrylic or polycarbonate material.

The light pipe may be formed from an optically clear material.

The kitchen appliance may be a coffee machine and the lighting arrangement may mounted underneath a brew head of the coffee machine and configured to direct light downwardly towards a coffee preparation area.

The kitchen appliance may be a coffee machine and the lighting arrangement may be mounted to a bean hopper of the coffee machine and configured to direct light upwardly along a wall of the bean hopper.

The lighting arrangement may be integrated with the bean hopper.

The lighting arrangement may be arranged to surround an accessory-receiving portion of the appliance.

The lighting arrangement may be operably associated with a function, mode, or operational status of the appliance, and the lighting arrangement is configured to illuminate one or more areas of the kitchen appliance according to a change in the function, mode, or operational status of the appliance.

There is also disclosed herein a method of illuminating a kitchen appliance using a lighting arrangement, the lighting arrangement including a light pipe having a start portion, an end portion, and an upper surface and an opposing lower surface, wherein the upper surface includes a plurality of facets that extend along a length of the light pipe between the start and end portions, the lighting arrangement including a light source, the method including:
positioning the light pipe around an accessory-receiving portion of the kitchen appliance;
emitting a light from the light source through the start portion of the light pipe; and
illuminating a length of the light pipe by reflecting the light across the plurality of facets.

The method may further include:
varying the size, height, or angle of the facets to vary the reflection of the light along the length of the light pipe.

The method may further include:
controlling the appliance to modify a wavelength of the light according to a function, mode, or operational status of the kitchen appliance.

There is also disclosed herein a kitchen appliance having a body and including:
a fluid container mountable to the body; and
a lighting arrangement associated with the fluid container, the lighting arrangement including a light source configured to direct a light into the fluid container to cause a first portion of the fluid container to have a first visual appearance and a second portion of the fluid container to have a second visual appearance that differs from the first visual appearance.

Preferably, when the fluid container is at least partially filled with a fluid, the first portion indicates the filled portion of the fluid container and the second portion indicates the empty portion of the fluid container, wherein the filled portion of the fluid container is illuminated and the empty portion of the fluid container is less illuminated to provide the contrasting first and second visual appearances.

Preferably, the fluid container includes:
a lower portion;
a front wall extending upwardly from the lower portion; and
an opposing rear wall extending upwardly from the lower portion, wherein the light source is located adjacent to the lower portion of the fluid container and configured to emit light towards the fluid container.

Preferably, the light source is mounted adjacent to the front wall of the fluid container and configured to direct light from the front wall towards the rear wall of the fluid container along a first path.

Preferably, a portion of the rear wall of the fluid container includes a reflective surface such that the light that is directed towards the rear wall from the light source reflects off the reflective surface to be subsequently directed towards the front wall along a second path.

Preferably, the light travelling along the second path is between approximately 40 to 85% of the light that is emitted by the light source.

Preferably, the light source is mounted adjacent to the rear wall of the fluid container and configured to direct light from the rear wall towards the front wall of the fluid container along a first path.

Preferably, the first and second portions of the fluid container are viewable through a water level window of the kitchen appliance.

Preferably, the light source is in the form of an LED 2835 that emits approximately 100 lumens of light.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIG. 1A is a schematic front view of a water level window of a kitchen appliance according to an embodiment of the present invention;

FIG. 1B is a further schematic front view of a water level window of a kitchen appliance according to an embodiment of the present invention;

FIG. 2 is a schematic perspective view of a water level window of a kitchen appliance according to an embodiment of the present invention;

FIG. 3 is a perspective view of a lighting system of a kitchen appliance according to an embodiment of the present invention;

FIG. 4 is a schematic view of a light contrast simulation/map of the lighting system of the kitchen appliance as shown in FIG. 3;

FIG. 5 is a schematic perspective view of a lighting system of a kitchen appliance according to another embodiment of the present invention;

FIG. 6 is a schematic view of a light contrast simulation/map of the lighting system of the kitchen appliance as shown in FIG. 5;

FIG. 7 is a rear perspective view of coffee machine incorporating a lighting system;

FIG. 8A is a schematic perspective view of a light pipe arrangement according to an embodiment of the present invention;

FIG. 8B is an enlarged view of a portion of the light pipe arrangement as shown in FIG. 8A;

FIG. 9A is a schematic perspective view of the light pipe arrangement shown in FIG. 8A with a visualisation of a path of light travelling through the light pipe;

FIG. 9B is an enlarged view a portion of the light pipe arrangement as shown in FIG. 9A;

FIG. 10 is a schematic perspective view of a portion of a coffee machine incorporating a light pipe arrangement;

FIG. 11 is a further schematic perspective view of the portion of a coffee machine incorporating a light pipe arrangement;

FIG. 12 is a schematic side cross-sectional view of a portion of a coffee machine incorporating a light pipe arrangement;

FIG. 13 is a schematic exploded view of the portion of a coffee machine shown incorporating a light pipe arrangement; and

FIG. 14 is a schematic side cross-sectional view of a bean hopper of a coffee machine incorporating a light pipe arrangement.

### DETAILED DESCRIPTION

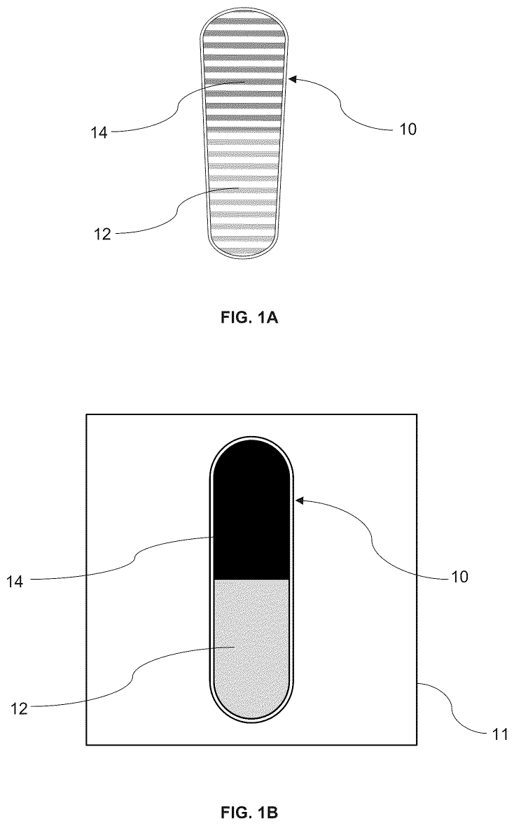

In FIGS. 1A, 1B, and 2 of the accompanying drawings, there is schematically depicted a water level window 10 of a kitchen appliance 11 according to an embodiment of the present invention. In this example, the kitchen appliance 11 is a coffee machine having a water container which stores water that is drawn by a pump of the coffee machine to extract coffee through a brew head or to steam/froth milk through a steam wand. It will, however, be understood that the invention is not limited specifically to coffee machines, and is applicable to other types of kitchen appliances. In the example depicted, the water container is located at the rear of the coffee machine. The water level window 10 is incorporated into the housing of the coffee machine and is associated with the water container to provide a visual indication to the user (from the front of the coffee machine, for example) regarding the level of water in the water container of the coffee machine. For the purposes of the specification, the term ‘water container’ may be used interchangeably with the term ‘fluid container’, as it is understood that the container is not limited to containing a specific type of fluid.

The water level window 10 provides a visual indication to the user of a first container portion 12 and a second container portion 14. In the examples shown, the water container is partially filled with a liquid, and the first container portion 12 represents the filled portion of the container, whilst the second container portion 14 represents the unfilled or empty portion container, or the headspace. In other words, the first container portion 12 may be defined by the volume of water in the container, whilst the second container portion 14 may be defined by the volume of air in the container. The water level window 10 may have a width of approximately 20 mm and a height of approximately 110 mm. It will, however, be appreciated that the dimensions (and shape) of the water level window 10 is not necessarily limited to the dimensions and shape as shown in the drawings and as described herein, and may be customised depending on the design requirements of the coffee machine or other kitchen appliance.

The coffee machine includes a lighting system having one or more light sources associated with the water container. In a preferred form, the coffee machine includes one light source. In the example of FIG. 2, the coffee machine includes a single light source 16 located at the bottom of the water container and/or below the water level window 10, with the light source 16 being configured to emit or direct light upwardly into the container. In other examples, the light source 16 may be located at a side or rear of the water container and/or water level window 10, or at any other position that may assist in optimising the water in the container as a guide for the light emitted by the light source 16.

The light source 16 may be a light-emitting diode (LED) which is controlled by a controller of the coffee machine to emit or direct light into the water container. When the water container is at least partially filled with water, the light emitted by the light source 16 illuminates the water in the water container, providing a visual indication to the user of a contrast between the filled portion of the container and the unfilled portion of the container. This visual indication is communicated through the water level window 10 of the coffee machine. The visual indication may also be communicated via the water container itself, which would typically have transparent or translucent wall portions. In the example as shown in FIGS. 1A, 1B, and 2, the light emitted by the light source 16 causes the first container portion 12 (being the filled portion of the container) to have an illuminated appearance, which is in visual contrast with the appearance of the second container portion 14 (being the unfilled portion or the headspace of the container). This difference or contrast in visual appearance is visible to the user through the water level window 10. As noted above, this difference or contrast in visual appearance may also be visible to the user via the water container itself. It will be appreciated that this functionality may at least provide a point of difference to typical arrangements whereby the volume of air in a container is illuminated (rather than the volume of water in the container), which is counter-intuitive. Accordingly, in at least an embodiment, the arrangement of the light source 16 of the present invention may at least provide a more distinctive and user-intuitive means for a user to determine the level of water (or other liquid) available in a container of a kitchen appliance.

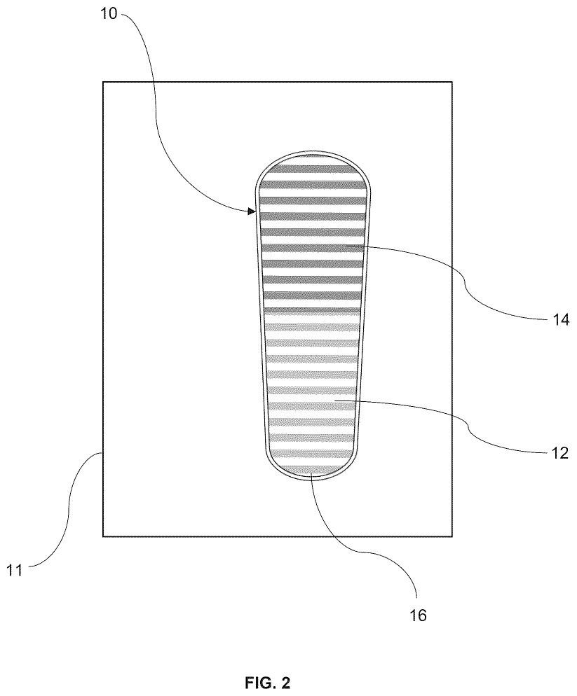

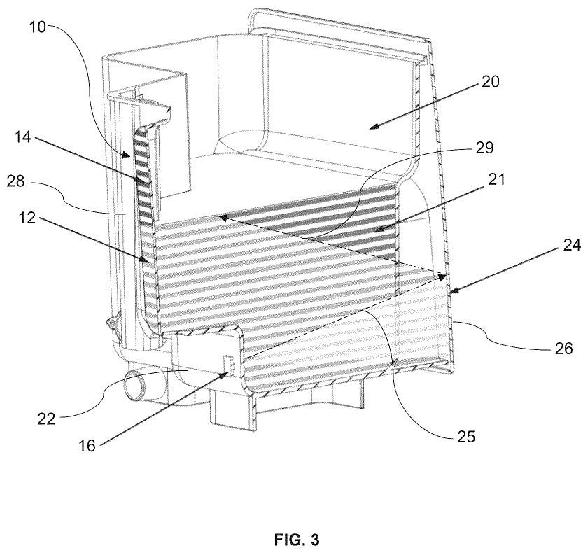

In one embodiment, and as best shown in FIG. 3, a water container 20 is shown with one version of the lighting arrangement. The water container 20 is shown to be partially filled with water 21. In this embodiment, the light source 16 is positioned at or around a lower (bottom) portion or wall 22 of the water container 20 and is mounted to the coffee machine or the water container 20 at a location that is adjacent a front portion of the water container 20. In this embodiment, the light source 16 is also located below the water level window 10. The light source 16 is arranged to direct light towards a rear portion or wall 24 of the water container 20 generally along a first path 25. The first path 25 may be angled upwardly away from the lower portion 22. In this embodiment, the rear wall 24 includes a reflective surface 26. It will be appreciated that the reflective surface 26 may be located along the entire rear wall 24, or may otherwise be located along any section or position along the rear wall 24 of the water container 20. In one example, the light source 16 may be in the form of an, such as an LED 2835, to emit 100 lumens (lm) of light. It will be appreciated that the form of the light source 16 may be otherwise configured depending on the design requirements of the coffee machine.

In the depicted embodiment, the light that is directed from the light source 16 travels through the water 21 in the container 20 along the first path 25, then bounces or reflects off the reflective surface 26 to subsequently be directed towards a front portion or wall 28 of the container 20 generally along a second path 29. In one example, the reflective surface 26 may be in the form of a mirror formed from aluminium. In this example, the reflected light may be approximately 85% of the light that is emitted by the light source 16. In another example, the reflective surface 26 may be in the form of a white reflective surface and in this example, the reflected light may be approximately 40% of the light that is emitted by the light source 16. It will be appreciated that the reflective surface 26 may be otherwise configured depending on the design requirements of the appliance.

In the embodiment of FIG. 3, the front wall 28 provides or includes the water level window 10 of the appliance. In the depicted Figures which show a partially filled container 20, the water level window 10 shows the first (i.e. filled) container portion 12 and the second (i.e. unfilled) container portion 14. It will be understood that, with this arrangement, the reflection of the light off the reflective surface 26 allows the first (i.e. filled) container portion 12 to be illuminated and viewable via the water level window 10, whilst the second (i.e. unfilled) container portion 14 has little to no illumination. Accordingly, this arrangement may allow for the level of water 21 in the container 20 to be easily determined by a user by way of the visual contrast between the filled and unfilled portions 12 and 14. It is important to note that the water 21 in the container 20 acts as the medium for the reflection and illumination.

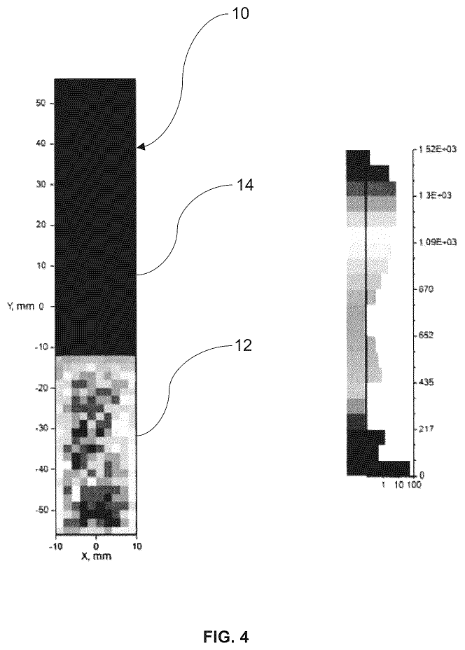

The water level window 10 may have a diffused or textured surface. In one example, the surface of the water level window 10 may have a Lambertian reflectance, which is generally understood to be a property that defines an ideal “matte” or diffusely reflecting surface. The diffused or textured surface may be one that obeys Lambert's law, or exhibits Lambertian reflectance. In this example, the diffused surface of the water level window 10 may be 80% transmitting, similar to white screenprinting. It will be appreciated that the use of a diffused surface may at least increase the contrast between the illuminated first container portion 12 (which is representative of the filled (water) portion of the container 20) and the less illuminated second container portion 14 (which is representative of the unfilled (air) portion of the container 20). The illumination of the water level window 10 in this embodiment may be exemplified by the light contrast simulation/map as shown in FIG. 4.

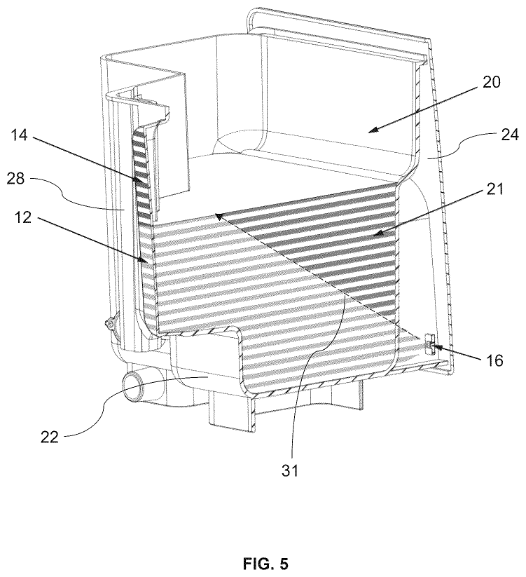

In another embodiment, and as best shown in FIG. 5, the water container 20 is shown with an alternate version of the lighting arrangement, with like reference numerals used to depict like features. The water container 20 is shown to be partially filled with water 21. In this embodiment, the light source 16 is positioned at or around the lower (bottom) portion or wall 22 of the water container 20 and is mounted to the coffee machine or the water container 20 at a location that is adjacent the rear of the water container 20. The light source 16 is arranged to direct light towards the front portion or wall 28 of the water container 20 along a path 31. In one example, the light source 16 may be in the form of an LED, such as an LED 2835, to emit 100 lumens (lm) of light. It will be appreciated that the form of the light source 16 may be otherwise configured depending on the design requirements of the appliance.

The front wall 28 provides or includes the water level window 10 of the appliance. In the depicted Figures which show a partially filled container 20, the water level window 10 shows the first (i.e. filled) container portion 12 and the second (i.e. unfilled) container portion 14. It will be understood that, with this arrangement, the light that is emitted by the light source 16 travels through the water 21 in the container 20 along the path 31, which allows the first (i.e. filled) container portion 12 to be illuminated and viewable via the water level window 10, whilst the second (i.e. unfilled) container portion 14 has little to no illumination. Accordingly, this arrangement may allow for the level of water 21 in the container 20 to be easily determined by a user by way of the visual contrast between the filled and unfilled portions 12 and 14. It is important to note that the water 21 in the container 20 acts as the medium for the reflection and illumination.

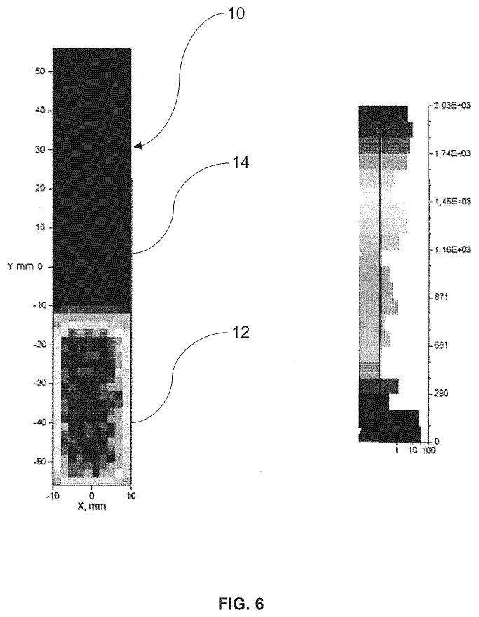

The water level window 10 may have a diffused surface. As discussed above, the surface of the water level window 10 may have a Lambertian reflectance, which is generally understood to be a properly that defines an ideal “matte” or diffusely reflecting surface. In this example, the diffused surface of the water level window 10 may be 80% transmitting, similar to white screenprinting. The diffused or textured surface may be one that obeys Lambert's law, or exhibits Lambertian reflectance. In this example, the diffused surface of the water level window 10 may be 80% transmitting, similar to white screenprinting. It will be appreciated that the use of a diffused surface may at least increase the contrast between the illuminated first container portion 12 (which is representative of the filled (water) portion of the container 20) and the less illuminated second container portion 14 (which is representative of the unfilled (air) portion of the container 20). The illumination of the water level window 10 in this embodiment may be exemplified by the light contrast simulation/map as shown in FIG. 6.

It will be appreciated that the illumination of the water 21 in the container 20 is not necessarily limited to the examples as shown in the drawings and as described herein, and may vary depending on the properties (e.g. position, type, intensity, etc.) of the light source 16 and the reflective surface 26, for example. It will be understood that the light source 16 may be positioned at any location along the lower (bottom) portion 22 or underside of the container 20 (i.e. adjacent the base of the container 20) to provide an illumination of the water in the container 20 that is visually contrasting. It will further be understood that some kitchen appliance models may not necessarily include the water level window 10 and that in such appliances, the arrangement(s) of the light source 16 described above may still provide for an illumination of the water in the container 20 that is visually contrasting and visible to the user.

In one embodiment, the illumination of the filled portion of the water container as described above is enabled by a set of calculations based on one or more parameters including, but not limited to, optical properties of liquid water, container size, and properties of the light source. Additionally, preliminary experimental results have shown that the illumination of the filled portion of the water container may potentially be an inverse of the natural dynamic at play—that is, if a light is emitted through water, the light may act as a ‘light pipe’, resulting in the illumination of the unfilled portion of the water container.

It will be appreciated that the arrangement above may provide a strong visual indication to the user of the water level in the water container, as the appearance of the water in the container has a more obvious, illuminated appearance, which contrasts strongly with the empty portion of the container.

In some embodiments, the water level window 10 may have a surface that is textured, or otherwise coated with materials having a strong diffusion to assist with providing a visual contrast. In other embodiments, only specific portions (such as graphics or indicators symbols) of the water level window 10 may include a diffused or textured surface to provide a more targeted illumination. In other embodiments, the water level window 10 may be provided with a perforated stainless steel surface to create a strong visual effect in conjunction with the contrast between the illuminated and less illuminated container portions. Additionally or alternatively, the lighting system may include one or more light prisms of varying sizes to assist with the visual indication and placed, for example, towards the rear of the container at an area of the container opposite the water level window.

It will further be appreciated that the lighting system above may be operatively associated with one or more sensors in electrical communication with the controller of the coffee machine. Such sensors may be configured to determine and communicate the level of water in the container to the controller, whereby the controller is configured to enable a pulsing or flashing operation of the light source to alert the user, for example when the level of water in the container is below a predetermined threshold. The controller may additionally or alternatively be configured to enable a range of coloured lights to be emitted to alert the user of the levels of water in the container. In this example, the one or more light sources do not necessarily need to be located near the water container at the rear of the coffee machine, and may additionally or alternatively be located at the front, side, bottom, or top of the coffee machine such that the light may provide a visual user alert function. The controller may be configured to modify or vary the wavelength of the lights according to a function, mode, or operational status of the machine.

In some embodiments, the coffee machine may include a further light source located at the bottom of the coffee machine, such that light emitted from the light source is cast onto the surface on which the coffee machine is located. The controller of the coffee machine may be configured to enable the light source to emit a red coloured light, for example, to provide a visual alert to the user that the level of water in the container is below a predetermined threshold.

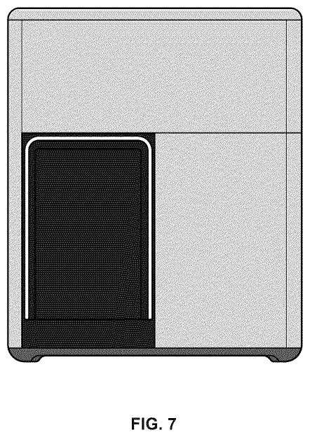

In a further embodiment of a coffee machine incorporating a lighting system, one or more light sources may be associated with other areas of the coffee machine, and controlled by the controller to provide a targeted illumination of the certain areas or zones of the coffee machine to provide a stage or zone lighting effect. For example, during the coffee extraction process, the lighting system may be controlled by the controller to emit a light from one or more of the light sources onto the group head area of the coffee machine. This may at least prompt the user to interact with the group head area, and may also provide better visibility for the user, especially of the group head area of the coffee machine, which is typically located in a poorly illuminated area of the coffee machine. This may also enhance the theatre and user experience of creating drinks. The lighting system may also be controlled by the controller to emit a light from one or more of the light sources onto the coffee bean grinding or dispensing areas, or the engine bay of a coffee machine (as shown in FIG. 7) to provide a targeted illumination of those areas.

The controller may also control the one or more light sources to emit a light that is of a particular temperature, or temperature range, that corresponds with a desired visual appearance of the extracted coffee. In this example, the perceived value of the extracted coffee (in the example of the coffee machine above) may be enhanced.

It will be appreciated that a targeted illumination of the coffee machine working area, in addition to other areas or zones of the coffee machine, may at least improve the aesthetics of the coffee machine and accentuate the industrial design elements (form, materials) of the coffee machine. The targeted illumination of certain areas or zones of the coffee machine may also assist or guide user interaction with the coffee machine by improving visibility and/or prompting the user to interact (or to avoid interacting) with a certain area or zone that is being used.

It further envisaged that the lighting system described above may be incorporated into multiple kitchen appliances that are in communication with one another over a central network. In this way, controllers of each appliance may be configured to coordinate the operation of the associated lighting system to prompt the user to interact with a certain area or zone of that appliance (for example, during preparation of food for the same meal). As noted above, a controller may be configured to modify or vary the wavelength of the lights according to a function, mode, or operational status of the machine.

It is envisaged that the one or more light sources may be provided by one or more light pipe arrangements. The light pipe may be a transparent or translucent component, and preferably an optically clear component. The light pipe may be moulded from a plastic such as acrylic or polycarbonate, that transmits and casts light evenly along a path. Other suitable polymers may be used. It is envisaged that one or more portions of the light pipe, such as an exit or end portion, may include a diffused or textured surface. The path of the light travelling along the light pipe may be defined by the design elements and/or structural configuration of the light pipe. As discussed above, such light pipe arrangements may be configured to direct and cast light onto to a desired area or zone of the coffee machine (or any other kitchen appliance). In a preferred form, a light pipe arrangement may provide an even distribution of light on the targeted area or zone via a minimal number of LEDs. It will be appreciated that the use of minimal LEDs to achieve what is typically done with multiple LEDs is desirable for cost reasons (smaller number of high quality components vs a large number of low quality components) and warranty reasons (reducing warranty risks of LED component failure). With multiple LED arrangements, if one LED fails, a dead spot is created which is undesirable both from a visual and maintenance/repair perspective. In a further embodiment of a coffee machine incorporating a lighting system, the one or more light sources, being in the form of a light pipe, may be provided with a dial or button of the coffee machine (or any other kitchen appliance).

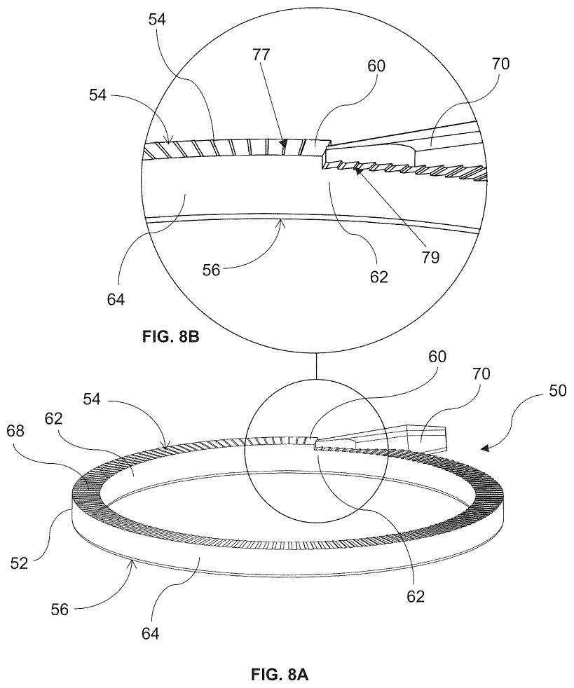

In one embodiment, and as best shown in FIGS. 8A and 8B, a light pipe 50 having a generally circular or ring-shaped body 52 is shown. The body 52 may have an outer diameter of approximately 100 mm, an inner diameter of between approximately 90 to 95 mm, and a height (i.e. a distance between an upper surface 54 and a lower surface 56 of the body 52) that ranges between approximately 5 to 30 mm. It will be appreciated that a greater overall height may be more aesthetically pleasing. In one preferred form, the body 52 may have a gradually decreasing height between a start portion 60 of the body 52 and a end portion 62 of the body 52). A width of the upper and lower surfaces 54 and 56 (i.e. a distance between an inner wall 64 and an outer wall 66 of the body 52) may be approximately 7 mm. It will be appreciated that the dimensions of the light pipe 50 is not necessarily limited to the dimensions as shown in the drawings and as described herein, and may be customised depending on the design requirements of the coffee machine or other kitchen appliance.

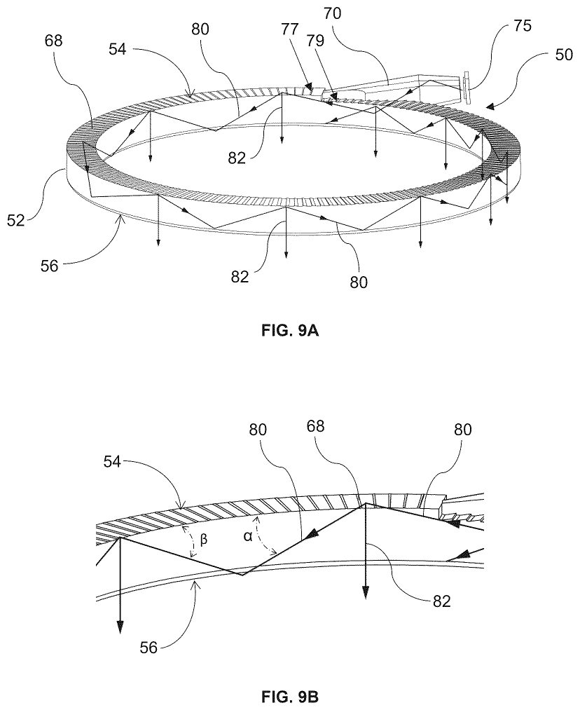

The upper surface 54 of the body 52 may include a faceted (stepped) arrangement. The faceted arrangement includes a plurality of facets (steps) 68 and may extend between the start portion 60 and the end portion 62 of the body 52. The facets 68 may be arranged along a spiral path that progresses along the upper surface 54 of the body 52. The facets 68 in the depicted embodiments are shown to be generally rectangular, although it will be appreciated that other shapes or configurations of the facets 68 (such as circular facets) are envisaged. The lower surface 56 of the body may be plain or preferably textured, or may provide a suitable surface that gives a diffused effect or appearance. In one example, the lower surface 56 may be a Lambertian surface. As the height of the body 52 at the start portion 60 is larger than the height of the body 52 at the end portion 62, at least the upper surface 54 slopes downwardly from the start portion 60 to the end portion 62. An entry portion 70 of the light pipe 50 is provided at or around the juncture between the start portion 60 and the end portion 62. The entry portion 70 may be fitted with a light source 75 (see FIG. 9A), which may include a single LED or a small number of LEDs. Light that is transmitted from the light source 75 may travel along a generally circular or revolving path between the start portion 60 and the end portion 62 of the body 52.

An exemplary illustration of a path of light that is transmitted by the light source 75 is shown in FIGS. 9A and 9B. It will be appreciated that the light path(s) shown in the drawings and as described herein are merely a simplification of the reflection that is occurring along the light pipe 50. In the depicted embodiment, the light path includes a primary path 80 that extends between the start portion 60 and the end portion 62 and one or more secondary paths 82 that extend from the primary path 80. Light that is transmitted by the light source 75 may travel through the body 52 along the primary path 80, whereby the faceted arrangement of the upper surface 54 may allow the light to be continuously reflected therebetween along the length of the body 52. In other words, the light may travel through the light pipe 50 from the start portion 60 and reflect/bounce between the facets 68 of the upper surface 54 and the lower surface 56, along the continuous primary path 80, until the light reaches the end portion 62. It will be appreciated that the faceted arrangement may include smaller facets 77 around or towards the start portion 60 and larger facets 79 around or towards the end portion 62. Accordingly, the size of the facets 68 may gradually increase from the start portion 60 to the end portion 62 such that the facets 68 become larger along the length of the body 50 as they get further away from the light source 75.

It is understood that a larger geometry (size, surfaces) of the facets 68 may more effectively reflect the light that is diminishing along the length of the body 52. This may be assisted by way of the height of the start portion 60 being larger than the height of the end portion 62. In one example, where a larger facet 79 located towards the end portion 62 may be calculated as having a 100% light reflection efficiency, a smaller facet 77 located towards the start portion 60 may have a light reflection efficiency of 50 to 60%. The facets 68 may have a width of approximately 7 mm. The height of each facet (step) 68 may be between approximately 1 to 1.5 mm. It is understood that the height of each facet (step) 68 plays a role in the size of the facets 68 and the amount of change of the size of the facets 68 along the length of the light pipe 50. Each of the facets 68 may also be disposed at an angle of between approximately 0 to 90 degrees relative to a horizontal axis of the light pipe 50. Each facet 68 may also include one or more angled or curved surfaces.

The faceted arrangement may also allow for the light to travel from the primary path 80 along the one or more secondary paths 82. As noted above, it will be appreciated that the light path(s) shown in the drawings and as described herein are merely a simplification of the reflection that is occurring along the light pipe 50. As depicted in the Figures, each of the secondary paths 82 extend from the primary path 80 in a generally downward direction (i.e. a direction that is generally transverse to the upper and/or lower surfaces 54 and 56 and generally parallel to the inner and outer walls 64 and 66). As described above, the light that is emitted from the light source 75 may travel through the body from the start portion 60 and reflect/bounce between the facets 68 of the upper surface 54 and the lower surface 56 along the continuous primary path 80 until the light reaches the end portion 62. An exemplary segment of the light path is shown in FIG. 9B. As the light from the light source 75 floods the light path, several vectors of reflections are created. The angles of these vectors vary along the path according to sheer size of the vectors created. In the simplified version shown in the Figures, when the light that is travelling along the primary path 80 hits a facet 68 of the upper surface 54, it reflects into two separate paths: a first path that is a continuation of the primary path 80 and a second path that defined by the secondary path 82. The first path may be at an angle α relative to the upper surface 54. It will be understood that the angle α (and the resulting vectors of reflection) will vary depending on the number, size, and angle of the facets 68. The light travelling along the first path of the primary path 80 from the upper surface 54 towards the lower surface 56 may then reflect/bounce off the lower surface 56, and continue on along the primary path 80 towards a further facet of the upper surface 54 at an angle β (and the resulting vectors of reflection) relative to the lower surface 56. It will also be understood that the number of segments that are defined by the light path will vary depending on the number, size, and angle of the facets 68. The arrangement of the facets 68 may therefore allow them to act as prisms that direct light along the length of the light pipe 50 and also away from the light pipe 50 to illuminate a particular area or zone of the appliance.

It will be appreciated that the path of light that travels through the light pipe 50 is not necessarily limited to the configuration as shown in the drawings and as described herein, and may vary depending on the properties (e.g. number, size, angle, etc.) of the facets 68 and the properties (e.g. position, type, intensity, etc.) of the light source 75.

It is envisaged that the arrangement of the light pipe 50 described above, which allows for the use of a minimal number of LEDs, may be used as an alternative to an array of multiple LEDs to illuminate an appliance. Known lighting arrangements with arrays/multiple LEDs usually result in hotspots (i.e. brighter areas directly around the LED, and dimmer areas away from the LED) along the length of the arrangement. This is particularly evident when used in a scenario where the light source is visible. Further, known lighting arrangements with arrays/multiple LEDs may be susceptible to failure. To achieve an even lighting effect along the length of the arrangement, many LEDs are required, which increases the likelihood of failure. The use of multiple LEDs may also be inefficient in terms of costs (multiple LEDs are more expensive than one or two LEDs) and space (multiple LEDs on a board can limit the application of lighting as more space is required). The use of the light pipe 50 with a minimal number of LEDs may at least alleviate one or more of the above issues. The use of the light pipe 50 may also allow the light source 75 to be located away from the visible illuminated part, which may assist with ease of packaging, allowing designers more freedom in packaging components in their designs. This arrangement may also allow the electronic components to be kept away from heat and/or moisture generated by the appliance. The use of a light pipe 50 as a visibly illuminated component of an appliance may also increase the aesthetic appeal of an appliance to a user, in addition to improving visibility at a particular area of the appliance and/or assisting or guiding user interaction with the appliance.

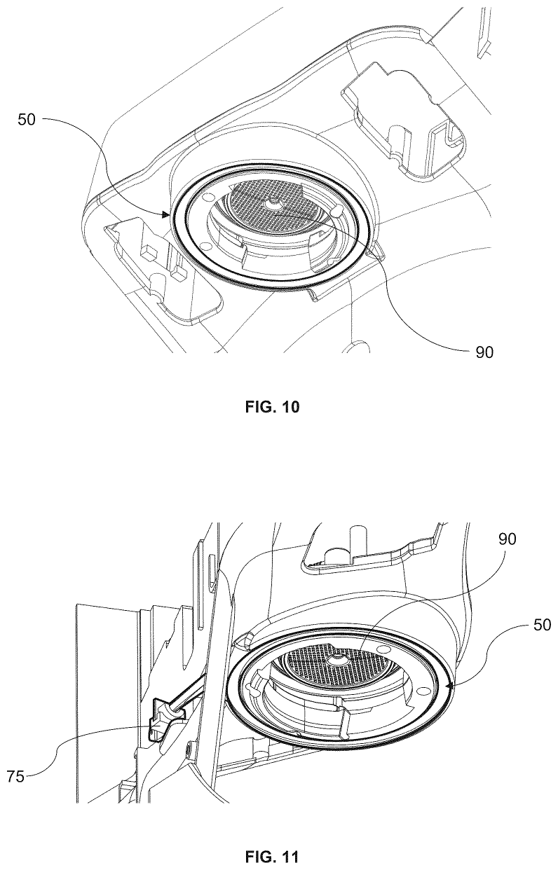

The illumination of an area of an appliance is shown in the example of FIG. 10, whereby the light pipe 50 is positioned at or underneath a brew head 90 of a coffee machine to illuminate the area around and directly below the brew head 90. In this instance, the light pipe 50 is also a visible component of the appliance to serve as a design element of the coffee machine. It will, however, be appreciated that in this example (and in other examples whereby the light pipe 50 is assembled to a kitchen appliance), the facets 68 of the light pipe 50 (which are disposed on the upper surface 54) are facing an underside surface of the machine, and therefore hidden from the view of the user. In this example, the user only sees the exposed lower surface 56, which may have a diffused or textured surface as described above. A further example of the light pipe 50 being positioned underneath the brew head of a coffee machine is shown in FIG. 11. It can be seen from this example that the light source 75 is positioned well away from the heat and/or moisture that may be generated from the brew head 92 during operation of the coffee machine. In other examples, the light pipe 50 may be arranged to surround one or more portions of the appliance which receives an accessory (such as a portafilter, a hopper, a stand mixer head).

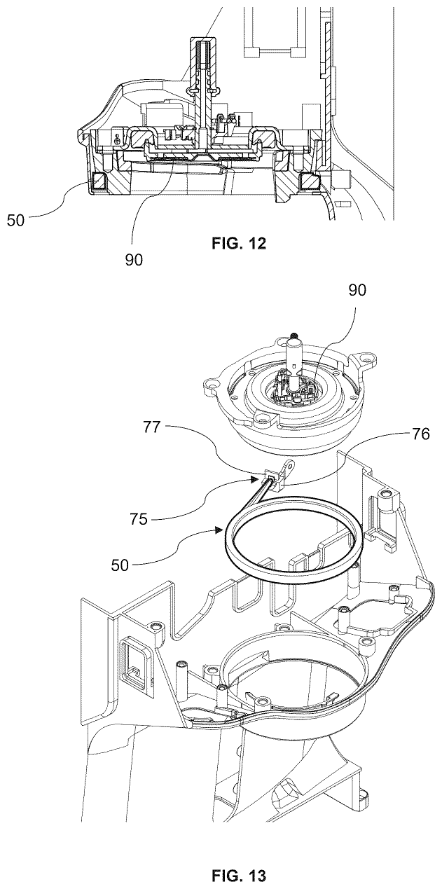

FIG. 12 shows a cross-sectional view of the arrangement of the light pipe 50 in a coffee machine, and FIG. 13 shows an exploded view thereof. It can be seen from the exploded view that the light source 75 may be supported by a housing 76, and a printed circuit board 77 of the light source 75 may be accurately aligned to the light pipe 50 via the housing 76.

It will be appreciated that the configuration of the light pipe 50 is not necessarily limited to the arrangement, dimensions, and shape as shown in the drawings and as described herein, and may be customised depending on the design requirements of the appliance.

As briefly discussed above, the use of a lighting arrangement with a kitchen appliance may provide a targeted illumination of certain areas or zones of the appliance to provide a stage or zone lighting effect. With coffee machines, for example, many of the user interaction zones of the machine are located in a typically poorly illuminated area underneath the head. The use of a lighting arrangement such as the light pipe 50 described above may improve user interaction with the coffee machine, as illumination provides better visibility. As described above, the light pipe 50 may be a visible component of the kitchen appliance to serve as a design element of the kitchen appliance and in examples whereby the light pipe 50 is assembled to a kitchen appliance, the facets 68 of the light pipe 50 (which are on the upper surface 54) are facing an underside surface of the machine, and therefore hidden from the view of the user. In this example, the user only sees the exposed lower surface 56, which may have a diffused or textured surface as described above. Further, the food result (e.g. the espresso being extracted) can be illuminated in a way that is showcased so as to improve the process of refining the result for the user. The lighting arrangement may also be configured in such a way that the particular temperature, or temperature range, of the light corresponds with a desired visual appearance of the food result. In this example, the perceived value of the food result may be enhanced. Such lighting arrangements which provide an evenly distributed stage or zone lighting effect may also improve the overall aesthetics or impression of the appliance, and can be configured to best accentuate the industrial design elements (e.g. form and materials) of the appliance. Such lighting arrangements may also assist or guide user interaction with the appliance by improving visibility and/or prompting the user to interact (or to avoid interacting) with a certain area or zone of the appliance that is being used.

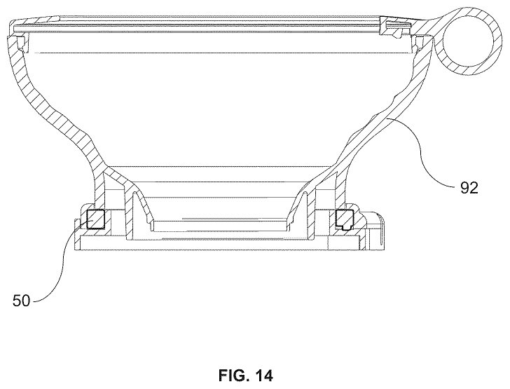

It is also understood that displays are not always the best way to communicate to prompt a user to a particular action. The part of an appliance that requires attention may be on a completely different part of the appliance to the display (e.g. the water container of a coffee machine being located at the rear of the machine, whilst the display is located at the front). In the example of the coffee machine, it is envisaged that the use of the lighting arrangements described above may improve user interaction with the machine in areas that are not limited to the brew head or the water container. In one example and as best shown in FIG. 14, a coffee bean hopper 92 (which typically has a transparent/translucent wall) of the machine may be illuminated with a pulsing light to prompt a user to refill the beans in the hopper 92 before it becomes an issue during the grinding process. In this example, the light from the light pipe 50 may also be projected upwardly into the transparent/translucent wall of the hopper 92 to increase the visibility of the illumination. In this example, the light pipe 50 is preferably battery powered. In a further example, the light pipe 50 may be incorporated into the hopper 92 so as to provide a single component. It will be appreciated that the configuration of the light pipe 50 of the coffee bean hopper 92 is not necessarily limited to the arrangement, dimensions, and shape as shown in the drawings and as described herein, and may be customised depending on the design requirements of the coffee machine.

The illumination of certain areas or components of the machine may also communicate a certain state (function, mode, operational status) of the machine, or otherwise improve the safety of the machine by communicating warnings (e.g. a hot surface). In one example, the illumination of certain areas or components of the machine may communicate a food type, a recipe, or other function or mode. In another example, the illumination of the machine in one colour may indicate that a door of the machine is open. The controller of the machine may otherwise be configured to modify or vary the wavelength of the lights according to a function, mode, or operational status of the machine. As briefly described above, the lighting system described above may be incorporated into multiple kitchen appliances that are in communication with one another over a central network. In this way, controllers of each appliance may be configured to coordinate the operation of the associated lighting system to prompt the user to interact with a certain area or zone of that appliance (for example, during preparation of food for the same meal).

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

1. A kitchen appliance including:
a lighting arrangement including:
a light pipe having a start portion, an end portion, and an upper surface and an opposing lower surface, wherein the upper surface includes a plurality of facets that extend along a length of the light pipe between the start and end portions; and
a light source associated with the light pipe and configured to emit light along the length of the light pipe.

2. The kitchen appliance of claim 1, wherein the light pipe has a generally circular or ring-shaped body.

3. The kitchen appliance of claim 1 or 2, wherein the light source is a single LED.

4. The kitchen appliance of any one of claims 1 to 3, wherein the facets are arranged along as a spiral path that progresses along the upper surface of the light pipe.

5. The kitchen appliance of any one of claims 1 to 4, wherein the facets have varying sizes or heights.

6. The kitchen appliance of claim 5, wherein the facets that are located towards the end portion are larger than the facets that are located towards the start portion.

7. The kitchen appliance of claim 6, wherein the size of the facets gradually increases between the start and end portions.

8. The kitchen appliance of any one of claims 1 to 7, wherein the facets have varying angles relative to a horizontal axis of the light pipe.

9. The kitchen appliance of claim 8, wherein each facet is disposed at an angle of between 0 to 90 degrees relative to the horizontal axis.

10. The kitchen appliance of any one of claims 1 to 9, wherein the start portion and the end portion are separated by a height.

11. The kitchen appliance of claim 10, wherein the height of the end portion is larger than the height of the start portion.

12. The kitchen appliance of any one of claims 1 to 11, wherein the facets that are located towards the end portion have a light reflection efficiency of approximately 100% and the facets that are located towards the start portion have a light reflection efficiency of between approximately 50 to 60%.

13. The kitchen appliance of any one of claims 1 to 12, wherein the light pipe is formed from an acrylic or polycarbonate material.

14. The kitchen appliance of any one of claims 1 to 13, wherein the light pipe formed from an optically clear material.

15. The kitchen appliance according to any one of claims 1 to 14, wherein the kitchen appliance is a coffee machine and the lighting arrangement is mounted underneath a brew head of the coffee machine and configured to direct light downwardly towards a coffee preparation area.

16. The kitchen appliance according to any one of claims 1 to 15, wherein the kitchen appliance is a coffee machine and the lighting arrangement is mounted to a bean hopper of the coffee machine and configured to direct light upwardly along a wall of the bean hopper.

17. The kitchen appliance according to claim 16, wherein the lighting arrangement is integrated with the bean hopper.

18. The kitchen appliance according to any one of claims 1 to 17, wherein the lighting arrangement is arranged to surround an accessory-receiving portion of the appliance.

19. The kitchen appliance according to any one of claims 1 to 18, wherein the lighting arrangement is operably associated with a function, mode, or operational status of the appliance, and the lighting arrangement is configured to illuminate one or more areas of the kitchen appliance according to a change in the function, mode, or operational status of the appliance.

20. A method of illuminating a kitchen appliance using a lighting arrangement, the lighting arrangement including a light pipe having a start portion, an end portion, and an upper surface and an opposing lower surface, wherein the upper surface includes a plurality of facets that extend along a length of the light pipe between the start and end portions, the lighting arrangement including a light source, the method including:
positioning the light pipe around an accessory-receiving portion of the kitchen appliance;
emitting a light from the light source through the start portion of the light pipe; and
illuminating a length of the light pipe by reflecting the light across the plurality of facets.

21. The method of claim 20, further including:
varying the size, height, or angle of the facets to vary the reflection of the light along the length of the light pipe.

22. The method of claim 21, further including:
controlling the appliance to modify a wavelength of the light according to a function, mode, or operational status of the kitchen appliance.
